(19) United States
(12) Patent Application Publication
(10) Pub. No.: US 2004/0210342 A1
(43) Pub. Date: Oct. 21, 2004

(54) Apparatus having telescopic arms for transfer of loads

(75) Inventor: Riccardo Magni, Modena (IT)

Correspondence Address: YOUNG & THOMPSON, 745 SOUTH 23RD STREET 2ND FLOOR, ARLINGTON, VA, 22202

(73) Assignee: MANITOU COSTRUZIONI INDUSTRIALI S.R.L., CASTELFRANCO EMILIA (MODENA) (IT)

(21) Appl. No.: 10/623,501

(22) Filed: Jul. 22, 2003

(30) Foreign Application Priority Data
Jul. 23, 2002 (IT) M02002A000209

(51) Int. Cl. G06F 19/00

(52) U.S. Cl. 700/245

(57) ABSTRACT

The apparatus comprises a first telescopic arm, exhibiting a lower portion rotatably constrained to a first horizontal hinge axis, a first motor for rotating the first telescopic arm; a second telescopic arm rotatably constrained to an upper portion of the first telescopic arm which upper portion is aligned with a longitudinal axis of the first telescopic arm at a second horizontal hinge axis; a terminal load support group for a load mounted on the second telescopic arm and a second motor for rotating the second telescopic arm.

### BACKGROUND OF THE INVENTION

The invention relates to an apparatus having telescopic arms for moving loads, in particular for moving building materials resting on pallets or platforms, from ground level up to various floor levels of a building under construction or, more in general, to raise and manipulate loads to even high levels in any industrial or agricultural level.

As is known, telescopic arm apparatus is generally associated to a frame of a vehicle, preferably a self-propelling vehicle which can be located, for example, in proximity of a vertical wall of a building under construction.

More precisely, an apparatus of the above-mentioned type comprises a first or main telescopic arm exhibiting a lower portion which is rotatable about a horizontal first hinge axis arranged on a support base, which in turn is associated to the frame of the vehicle.

A first motor constituted by a pair of hydraulic actuators enables the first telescopic arm to be rotated into a plurality of positions comprised between a horizontal lowered position and a raised position of maximum inclination with respect to a horizontal plane.

Generally, in the prior art, a second telescopic arm is provided, associated to an upper portion of the first arm and exhibiting a front end on which a terminal support group of a load is mounted, for example comprising a fork for engaging and supporting a platform or pallet.

In a first example from the prior art, for example described in U.S. Pat. No. 4,382,743, the upper portion of the first arm is constituted by a small support arm fixed to a straight upper element of the first arm itself, and angled with respect to the longitudinal axis of the first arm so as to be arranged horizontally when the first arm is in a maximum inclination position. The second telescopic arm is rotatably constrained to an end of the small support arm about a second hinge axis, horizontal and parallel to the first hinge axis, about which the main telescopic arm rotates.

The end support group of the load in the above-cited patent is solidly constrained to the front end of the second telescopic arm and follows the latter rigidly in the angular displacements thereof.

The prior art described above exhibits some limitations and drawbacks, the principal of which is that the second telescopic arm has to be kept constantly horizontal as the inclination of the first arm varies, so that the load support group rigidly constrained thereto can also be maintained in a horizontal operative position.

In practice it is not possible to incline the second telescopic arm in order to move a load below the transport plane of the vehicle, as is necessary, for example, when the terminal fork has to be lowered to the level of a cellar or a room situated below ground level.

More in general, the second arm cannot be used in alignment with the first telescopic arm in cases where the length of the first arm is insufficient for the purpose; nor can it be rotated to overcome obstacles and barriers which might be situated at the various levels to which the load is to be transferred.

Another important point is that the small support arm fixed rigidly superiorly to the main first telescopic arm can be an obstacle in some of the first telescopic arm manoeuvres, and in any case renders necessary a location of the vehicle bearing the apparatus at a fair distance, for example, from the facade of a building the apparatus is being used to lift loads to.

A second prior art document, U.S. Pat. No. 4,553,899, attempts to overcome the above-cited drawbacks by having the terminal support group of a load rotatably constrained to the front end of the second telescopic arm, which in turn exhibits a posterior element unremovably fixed to the upper portion of the first arm so as to form a non-modifiable angle of about 110° between the longitudinal axes of the first arm and the second telescopic arm.

This second cited prior art, though allowing the terminal support group of a load to be kept constantly horizontal, even varying the inclination of the first and the second arm, angularly blocked relatively to one another, still has the drawback of requiring rather complex manoeuvres, as it is often necessary, for example when the terminal support group is to be displaced horizontally, to coordinatedly command not only the variation of the angulation of the first and second arms, but also a contemporaneous lengthening or shortening of the arms.

Further, the invariability of the angle between the longitudinal axes of the first and second telescopic arm in some situations can contribute to causing considerable difficulties in enabling the terminal load support group to overcome various types of obstacle, such as scaffolding, balcony parapets, window sills and so on.

In these situations the technical achievement which the present invention seeks to attain is to provide an apparatus having telescopic arms for movement of loads which obviates the above-mentioned drawbacks.

In the ambit of the invention, a further important aim is to provide an apparatus having telescopic arms which is highly dextrous in the movement of loads, enabling the loads to be moved easily and to various height levels, beyond obstacles which might be present even below the level of the vehicle on which the apparatus is mounted.

A further important aim of the invention is to provide an apparatus having telescopic arms which enables a displacement of the terminal load support group in a horizontal direction and at various height levels by means of simple manoeuvres of each single arm.

A further aim of the invention is to provide an apparatus which, though having telescopic arms of a similar length to apparatus in the prior art, can lift loads to a higher level.

### SUMMARY OF THE INVENTION

The set technical aims are achieved by an apparatus having telescopic arms which is characterised in that the upper portion of the first arm is aligned with the longitudinal axis of the first arm and the second telescopic arm is rotatably engaged to the upper portion about a second hinge axis which is horizontal and parallel to the first axis, and is further characterised in that it comprises a second motor which rotates the second telescopic arm about the second horizontal axis.

### BRIEF DESCRIPTION OF THE DRAWINGS

Further characteristics and advantages of the present invention will better emerge from the detailed description that follows of the device, illustrated purely by way of a non-limiting example in the accompanying figures, in which:

FIG. 1 is a lateral view of the apparatus of the invention in various operational configurations;

FIG. 2 is a partial lateral view of the apparatus of FIG. 1, in which the second telescopic arm is represented in a retracted position, aligned with respect to the first arm;

FIG. 3 is a similar view to that of FIG. 2, but with the second telescopic arm completely extended;

FIG. 4 is a view similar to that of FIG. 2 but with the second telescopic arm arranged at a transversal angle with respect to the first arm;

FIG. 5 is a series of operational configurations assumed by the apparatus of FIG. 1;

FIG. 6 is a similar figure to FIG. 5, but with an apparatus mounted on a support base which is rotatable with respect to the frame of the vehicle.

### DESCRIPTION OF THE PREFERRED EMBODIMENTS

With reference to the figures of the drawings, the apparatus with telescopic arms according to the invention is indicated in its entirety by 1.

It comprises a first or main telescopic arm 2 exhibiting a lower portion 2a rotatably constrained about a first horizontal hinge axis 3 arranged on a support base 4 associated to the frame 5 of a vehicle 6.

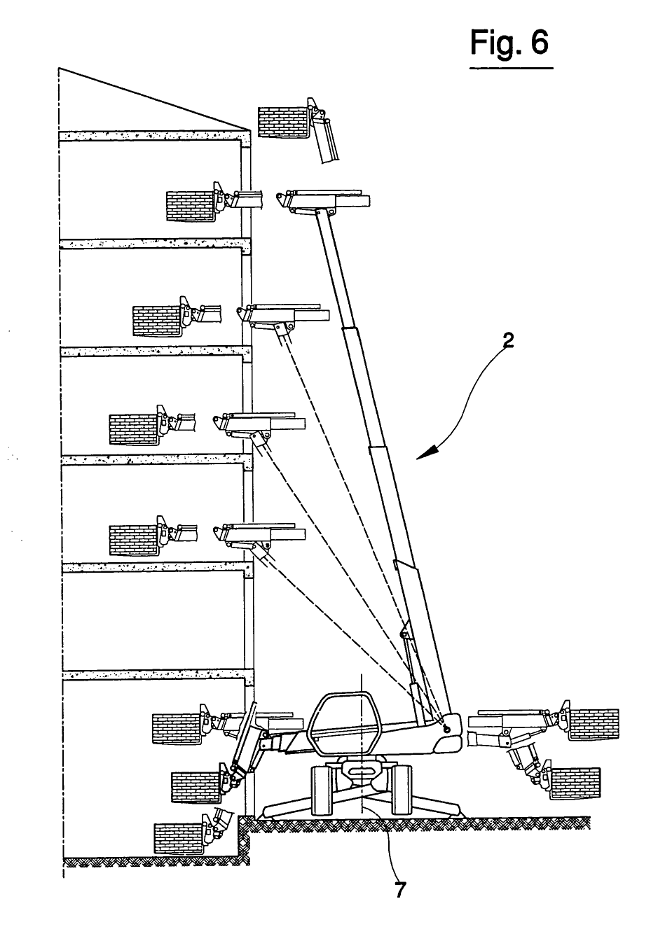

The support base 4 can be fixed with respect to the frame 5 or rotatable with respect thereto about a vertical rotation axis 7, forming a rotating tower (see FIG. 6).

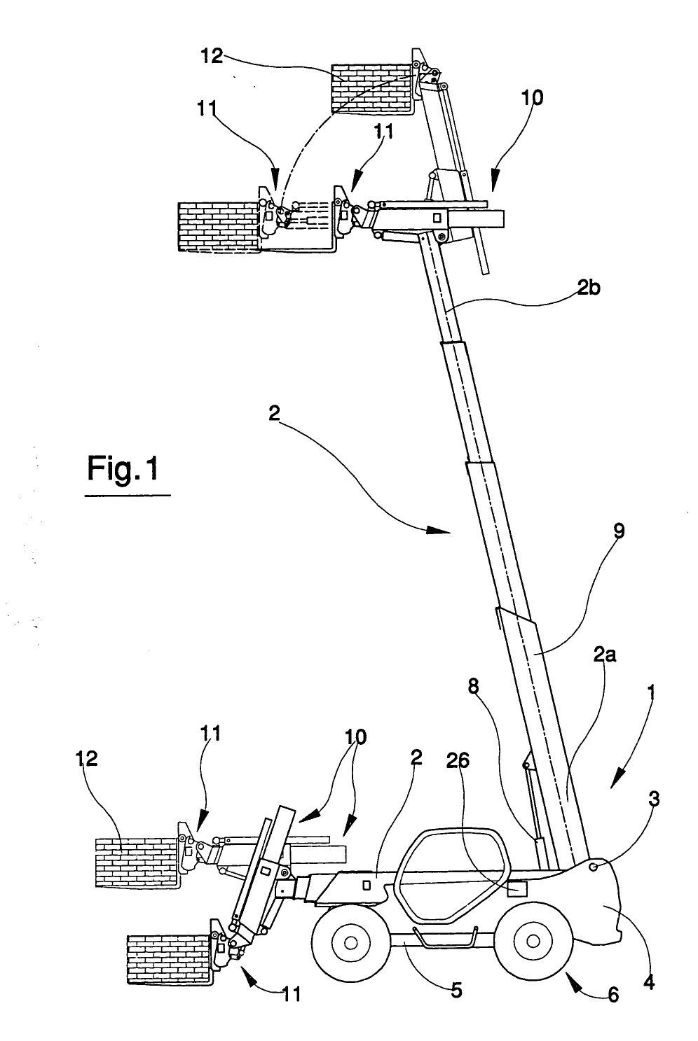

The first telescopic arm 2 can be rotated into various positions comprised between a horizontal lowered position and a raised maximum-inclination position with respect to a horizontal plane (see FIG. 1) by means of a first motor 8, for example constituted by a pair of hydraulic actuators constrained at ends thereof to the support base 4 and to a lower element 9 of the first arm 2.

A second telescopic arm 10 is constrained to an upper portion 2b of the first arm 2. The second telescopic arm 10 exhibits a front end 10a on which a terminal load support group 10 is mounted.

Initially the upper portion 2b of the first arm 2 is straight and aligned with the longitudinal axis 2c of the first arm 2. The second telescopic arm 10 is rotatably constrained about a second horizontal hinge axis 13 to the first upper portion 2b of the first arm 2. The second telescopic arm 10 can be rotated by a second motor 14, advantageously constituted by one or two hydraulic actuators.

In more detail, the second telescopic arm 10 comprises at least one pair of elements, namely a posterior external element 15 exhibiting an attachment lug 15a rotatably constrained to the upper portion 2b of the first arm 2 about the second hinge axis 13, and a front internal element 16 coupled slidably to the posterior internal element 15.

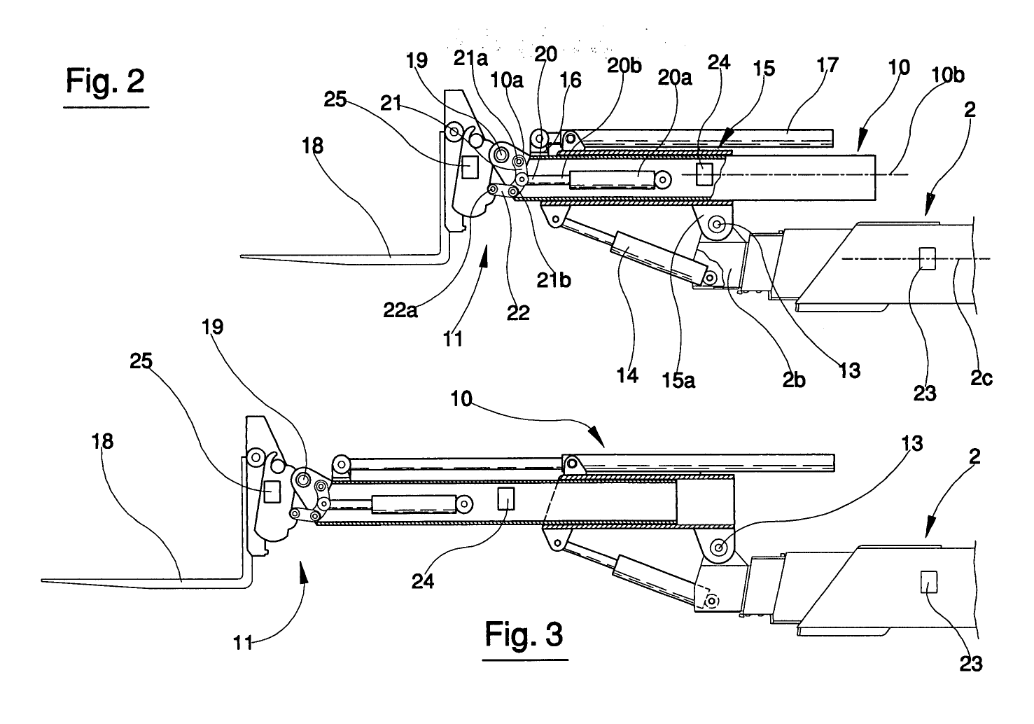

A telescopic hydraulic cylinder 17 connected both to the posterior external element 15 and to the front internal element 16 enables the front internal element 16 to be extracted or retracted so as to elongate or shorten the second telescopic arm 10 (see FIGS. 2 and 3).

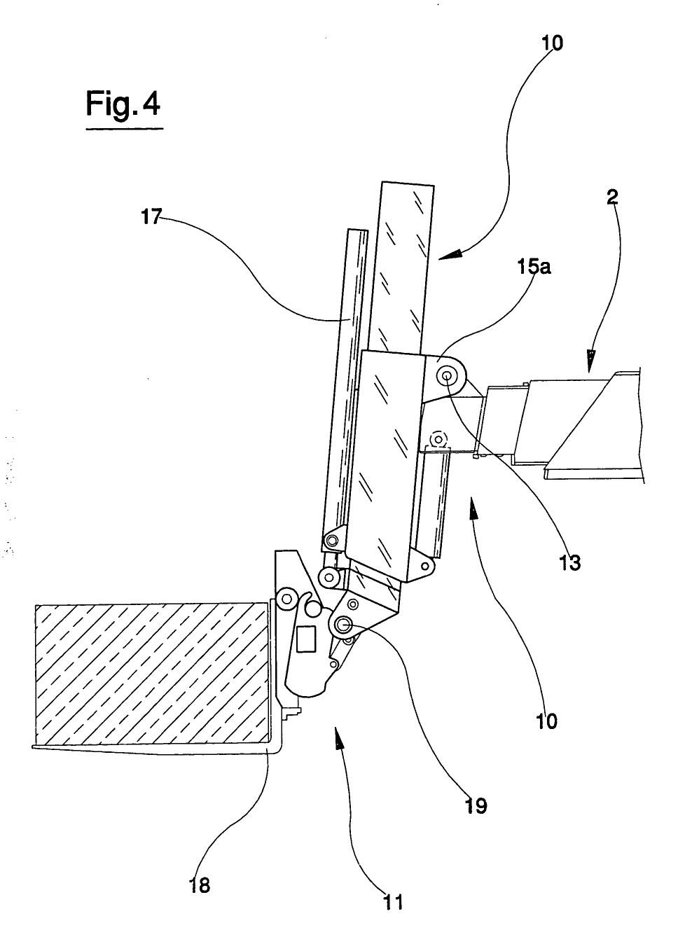

The hydraulic actuator 14 is terminally connected to the first upper portion 2b of the first arm 2 and to the external posterior element 15 of the second arm 10 and rotates the second arm 10 into operative positions comprised between a first extreme position, in which the longitudinal axis 10d of the second arm 10 is aligned with the longitudinal axis 2c of the first arm 2 (see FIGS. 2 and 3), and a second extreme position, in which the longitudinal axis 10b is angled almost transversally with respect to the longitudinal axis 2a (see FIG. 4).

The terminal load support group 11, which comprises, for example, a fork element 18 for engaging and supporting a platform or pallet, is in turn rotatably engaged to the front end 10a of the second telescopic arm 10 about a third horizontal hinge axis 19, parallel to the first hinge axis 3 and the second hinge axis 13. A third motor 20, constituted for example by one or two hydraulic actuators, rotates the load support group 11 about the third hinge axis 19.

More precisely, the one or two hydraulic actuators of the motor 20 are inserted internally of the front element 16 of the second arm 10 and exhibit a cylinder end 20a which is constrained to the second arm 10 and a stem 20b which is connected to a first lever 21. The first lever 21 is hinged at a first end 21a to the front element 16 and at a second end 21b to a second lever 22, which second lever 22 is hinged by an oscillating hinge 22a to the load support group 11.

The elongation or retraction of the stem 20b of the cylinder 20 causes the rotation of the first lever 21 about the first end 21a and consequently causes the second lever 22 to oscillate, in turn causing the load group 11 to rotate about the third hinge axis 19.

Three angular displacement sensors are provided, comprising: a first sensor 23 associated to the first arm 2, a second sensor 24 associated to the second arm 10 and a third sensor 25 associated to the load support group 11.

There is also an electronic control unit 26 for processing the data provided by the sensors 23, 24 and 25, which then sends command signals, at least to the hydraulic actuators of the motors 14 and 20, in order to keep the terminal load group 11 in a constantly level horizontal position when the arm 2 and/or the second telescopic arm 10 position is varied. Also, the second telescopic arm 10 can thus be kept horizontal when the load is to be moved in a horizontal direction.

Alternatively, the operator can overrule the electronic unit 26 and directly control the operations of the hydraulic actuators 14 and 20.

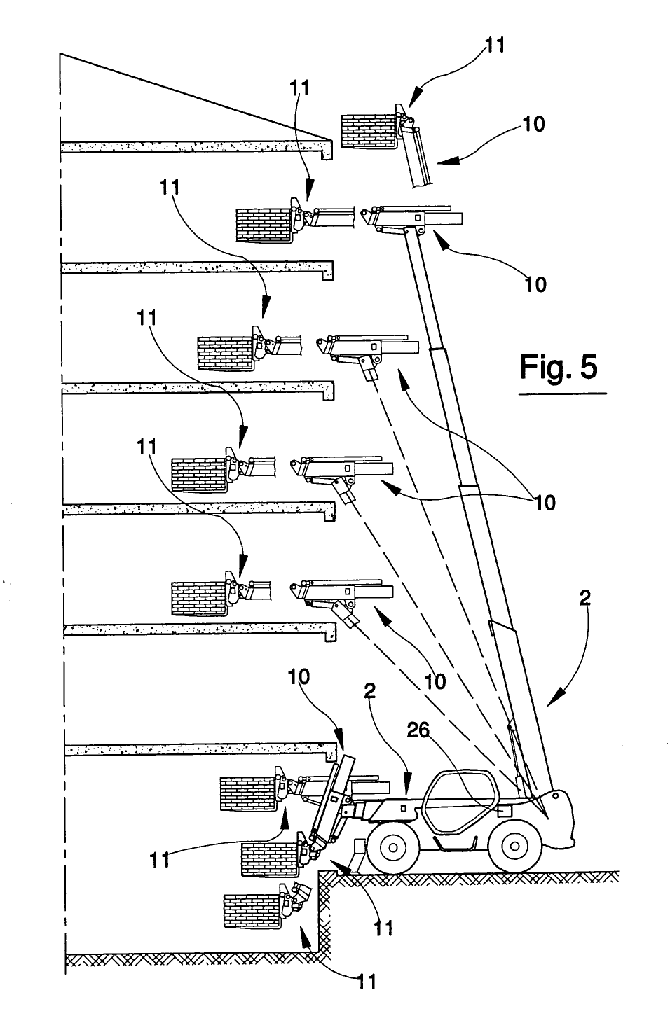

The use of the above-described apparatus 1 with telescopic arms is as follows, and is illustrated especially in FIGS. 5 and 6.

In order to raise the loads to levels above the rest plane of the vehicle 6, the first arm 2 is rotated about the first hinge axis 3 and extended to the desired amount. During this stage the second arm 10 is advantageously kept in alignment with the first arm 2 so that the terminal load group 11 is side by side with the first arm 2.

Subsequently, the second arm 10 is rotated until it comes into a horizontal and extended position, so as to transfer the load (maintaining a horizontal position) towards the inside of, say, a floor of a building to which level the load has been raised.

The initial alignment of the second arm 10 to the first arm 2 enables the vehicle to be brought as close as possible to the vertical wall of the building into which the loads are to be transferred at various levels.

Should it be necessary to transfer the loads below the level at which the vehicle is operating, the first arm 2 is kept horizontal and the second arm 10 is rotated until it has the correct inclination, whereupon it is extended to lower the load to the desired level.

It is important to note that during the manoeuvres where it is necessary to incline the second arm, the third hydraulic actuator 20 keeps the terminal load group in a horizontal position.

The invention offers considerable advantages.

Firstly, the presence of the second horizontal hinge axis about which the second telescopic arm can rotate, and the third hinge axis about which the terminal load group can rotate, confer considerable dexterity on the whole apparatus, especially in moving the load to various levels both above and below the level at which the vehicle is situated.

Further, to be noted is the ability to align the second arm with the main arm, which not only in some cases increases the maximum height reachable by the apparatus, but also enables the vehicle to be brought very close to the perimeter wall of a building, while enabling the vehicle to be kept immobile throughout the following manoeuvres.

Finally, the horizontal displacements of the loads raised to very considerable heights can be carried out exclusively through extending and retracting manoeuvres of the second arm.

What is claimed:

1). An apparatus having telescopic arms for transfer of loads, comprising:
a first telescopic arm exhibiting a lower portion which is rotatably constrained about a first horizontal hinge axis arranged on a support base associated to a frame of a vehicle;
a first motor for rotating the first telescopic arm into a plurality of positions comprised between a lower horizontal position and a raised position of maximum inclination with respect to a horizontal position;
a second telescopic arm associated to an upper portion of the first telescopic arm;
a terminal load support group for a load, which terminal load support group is mounted on a front end of the second telescopic arm;
wherein the upper portion of the first telescopic arm is aligned with a longitudinal axis of the first telescopic arm and the second telescopic arm is rotatably constrained to the upper portion about a second horizontal hinge axis which is parallel to the first hinge axis;
and wherein it comprises a second motor for rotating the second telescopic arm about the second horizontal hinge axis.

2). The apparatus of claim 1, wherein the second motor rotates the second telescopic arm into operative positions comprised between a first extreme position, in which the second telescopic arm is aligned with the first telescopic arm and a second extreme position in which the second telescopic arm is angled transversally with respect to the first telescopic arm.

3). The apparatus of claim 1, wherein the terminal load support group of the load is rotatably constrained to the front end of the second telescopic arm about a third horizontal hinge axis which is parallel to the first hinge axis and to the second hinge axis, and characterised in that it comprises a third motor for rotating the support group about the third horizontal hinge axis.

4). The apparatus of claim 3, wherein it comprises at least a first sensor for detecting angular displacements, associated to the first telescopic arm, at least a second sensor of angular displacements associated to the second telescopic arm, at least a third sensor of angular displacements, associated to the terminal load support group, and an electronic control unit for processing the data arriving from the first, second and third sensors and for emitting command signals at least to the third motor in order to maintain a constant angle for the load support group with respect to ground level when an inclination of the first telescopic arm and the second telescopic arm is varied.

5). The apparatus of claim 3, wherein the first, second and third motors comprise at least one hydraulic actuator for each hinge axis.

6). The apparatus of claim 1, wherein the support base is rotatable with respect to the frame of the vehicle about a vertical rotation axis.
